(19) United States
(12) Patent Application Publication
(10) Pub. No.: US 2009/0017185 A1
(43) Pub. Date: Jan. 15, 2009

(54) STEVIA-CONTAINING TABLETOP SWEETENERS AND METHODS OF PRODUCING SAME

(76) Inventor: Steven J. Catani, Athens, GA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/147,168

(22) Filed: Jun. 26, 2008

Related U.S. Application Data
(60) Provisional application No. 60/947,102, filed on Jun. 29, 2007.

(51) Int. Cl. A23L 1/236; A23G 3/48

(52) U.S. Cl. 426/658

(57) ABSTRACT

A reduced calorie sweetening composition having stevia extract and a simple sugar, wherein the stevia has a rebaudioside A level of from about 80 wt % to about 99 wt % relative to all steviol glycosides. The sweetener composition can be formulated as non-free flowing solids, powders, granules, or as liquids.

### CROSS REFERENCE TO RELATED APPLICATIONS

This application claims the benefit of priority from U.S. Provisional Patent Application No. 60/947,102, filed on Jun. 29, 2007, the content of which is incorporated by reference.

### FIELD OF THE INVENTION

The present invention is directed to stevia-containing tabletop sweetener compositions and methods of making such compositions. The stevia-containing sweetener compositions of the present invention include simple sugars.

### BACKGROUND OF THE INVENTION

People often customize the taste of food and beverages by adding sweeteners thereto. For example, tabletop sweeteners are added to beverages, such as, coffee and tea; on cereals; on fruit; and as toppings on baked goods. Sweetening a food or beverage with a tabletop sweetener alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for tabletop sweetener products that consumers may use to increase the sweetness of a product at the time of consumption that are consistent with their personal preferences and minimize additional caloric burden.

Tabletop sweeteners are a primary vehicle by which such taste customization is accomplished. Tabletop sweeteners are presently available in many different forms, including, granular, tablets, cohesive non-free flowing compositions (e.g., cubes), and the like.

Many types of sweeteners are available as tabletop sweeteners. These include natural sweeteners, such as, sucrose (i.e., cane sugar), honey, high fructose corn syrup, molasses, maple syrup, brown rice syrup, fruit juice sweeteners, barley malt, stevia and the like, as well as artificial sweeteners, such as, sucralose, aspartame, saccharin and the like.

Commonly available sweeteners have slightly different tastes that are variably preferred by individuals. Many sweeteners impart a bitter taste to the foods they sweeten. Saccharin, for example, is a sweetener that is known to impart a bitter taste. Other sweeteners have other taste components such as lingering metallic tastes, cooling or drying sensations, or combinations of the above sensations. Food ingredients have been used to overcome the bitterness. For example, cream of tartar is included in commonly sold saccharin packets. Additionally, several organizations, such as the Linguagen, have recently disclosed compounds that block bitter taste by modifying taste receptor signaling.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in wide spread use, is produced from many sources, e.g., sugar cane and sugar beet roots.

Sugar alcohols are another form of sweetener. Sugar alcohols vary in sweetness from about half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to nutritive sweeteners. Some high intensity sweeteners, such as, aspartame, are nutritive, but are so intense that they still provide negligible calories because very small amounts are required. Other high intensity sweeteners, such as, for example sucralose, are not absorbed when ingested and are, therefore, non-nutritive sweeteners.

Often the makers or users of these sweeteners add other components to them to overcome a less pleasant taste, for example, a bitter taste. For example, cream of tartar may be added to saccharin to offset its bitterness; and 2,4-dihydroxybenzoic acid may be added to sucralose to control lingering sweetness.

Stevia is a non-caloric natural sweetener from the plant Stevia rebaudiana bertoni. The plant makes a number of sweet compounds collectively referred to as steviol glycosides, which make stevia 300 times sweeter than sucrose. These glycosides can be extracted from the plant with water and other solvents well known to those skilled in the art. They are heat stable, pH stable, do not ferment, and do not induce a glycemic response.

Of the glycosides found in stevia extracts, rebaudioside A is known to have the least aftertaste. This aftertaste described by many as bitter and licorice like, which is present in all current stevia extracts. While stevia extracts have many excellent properties, improvements in their taste profile would clearly be desirable.

Like with all high intensity sweetener containing sweetener compositions, stevia containing sweetener compositions typically have been provided with a bulking agent to aid in measurement and distribution into the users application. Among those disclosed or used include FOS and other fibers, maltodextrins, and erythritol. Erythritol is especially popular as it can mitigate some of the bitter taste.

Surprisingly, we discovered sweetening compositions where the bitter/licorice taste of rebaudioside A is modulated by simple sugars (e.g., refined sucrose), but not by complex sweeteners, e.g., maple and molasses. This is surprising as complex sugars have an inherent multidimensional taste would tend to “hide” the licorice note from the rebaudioside. Even more surprising, the simple sugars, which have only sweet taste, modulate the licorice note from rebaudioside A even when they contribute less than half the sweetness of the sweetening composition. Thus, it is surprising that the combination of low stevia levels, high purity rebaudioside A, and a simple refined sugar, such as sucrose or fructose, creates a sweetener composition with much lower characteristic licorice taste of stevia.

These have not been previously used due to the apparent contradiction of using a simple sugar in formulations which are inherently sugar substitutes.

### SUMMARY OF THE INVENTION

A reduced calorie sweetening composition comprising, consisting of, and/or consisting essentially of a stevia extract and a simple sugar, wherein stevia provides from about 20% to about 97% of the sweetness and has a rebaudioside A level of from about 80 wt % to about 99 wt % relative to all steviol glycosides.

A sweetening composition comprising, consisting of, and/or consisting essentially of stevia and a simple sugar selected from the group consisting of sucrose, fructose, glucose, and mixtures thereof, wherein the stevia has a rebaudioside A level of from about 80 wt % to about 99 wt % relative to all steviol glycosides.

A reduced calorie sweetening composition comprising, consisting of, and/or consisting essentially of from about 2 wt % to about 4 wt % stevia extract and about 90 wt % to about 98 wt % simple sugar, wherein the stevia has a rebaudioside A level of from about 80 wt % to about 99 wt % relative to all steviol glycosides.

### DETAILED DESCRIPTION

As used herein, the term “high intensity sweetener” means a substance that provides a high sweetness per unit mass compared to a nutritive sweetener and provides little or no nutritive value. Many high intensity sweeteners are known to those skilled in the art and any may be used in the present invention. Examples of high intensity sweeteners useful in the present invention include, for example, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, extracts of sweet plants, such as stevia, thaumatin, salts, and combinations thereof. A preferred high intensity sweetener according to the present invention is sucralose.

As used herein, the term “sugar alcohol” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, a “food-grade” material is one that conforms to the standards for foods deemed safe for human consumption set forth in the Codex Alimentarius produced by the World Health Organization (1999).

As used herein, a g. (or other given amount) of Sucrose Equivalent Sweetness (“SES”) means the amount of high intensity sweetener needed to be added to an 8 ounce glass of water in order to provide the same sweetness as an independent 8 ounce glass of water containing one g. (or the other given amount) of sucrose. For example, 1/200 g of aspartame will equal about one g. of SES because aspartame is about 200 times sweeter than sucrose. Similarly, about 1/500 g to about 1/600 g of sucralose will provide one g. of SES because sucralose is about 500 to about 600 times sweeter than sucrose.

As used herein, all numerical ranges provided are intended to expressly include at least all numbers that fall between the endpoints of ranges.

Preferably, the sweetening compositions of the present invention contain from about 1 gram to about 10 gram of SES.

A clean sweet tasting sweetener composition can be made from stevia extract provided certain conditions are met. First, stevia extract concentrated in rebaudioside A is used. Second, bulking agents are limited to simple sugars, specifically sweet, mono and disaccharide. Third, the stevia extract provide no more than 97% of the sweetness of the sweetening composition.

### Stevia

Stevia is the extracts of the native South American plant Stevia Rebaudiana Compositae Bertoni. Stevia rebaudiana is native in South America. Its first known use was in Paraguay, but both the plant and extracts have been used for many years as a sweetener in South America, Asia, including Japan and China. It also has a broad audience in the United States where it is sold as a dietary supplement rather than as a sweetener due to its current regulatory status. As used herein Stevia refers to the plant, a stevia extract to the broad collection of steviol gylcosides which are found in the plant, and Stevioside and rebaudioside refer to specific steviol gylcosides.

Stevioside, sometimes referred to as stevia, (13-[(2-O-β-D-glucopyranosyl)oxy]-kaur-16-en-18-oic acid-4α-β-D-glucopyranosyl ester) and rebaudioside A are exemplary glycosides of the diterpene derivative steviol, extracted and refined from Stevia rebaudiana bertoni (also known as eupatorium rebaudianum bertoni) leaves. These glycosides are high intensity sweeteners, about 100 to about 500 times that of sucrose, but have metallic and bitter notes. They can be used in a wide range of low or reduced calorie food products and beverages.

Other sweet glycosides can also be extracted from Stevia rebaudiana. These have varying degrees of sweetness. As used herein “stevia extract” means a sweet glycoside extracted from a stevia plant. Table 1 contains typical glycoside compositions in the stevia plant leaves.

TABLE 1

| | Concentration in Leaves | | | % of Glycosides |
|---|---|---|---|---|
| Steviol Glycoside | low | high | average | average |
| Stevioside | 5% | 22% | 14% | 57% |
| Rebaudioside-A | 1.50% | 10% | 6% | 24% |
| Rebaudioside-B | 0% | 4% | 2% | 8% |
| Rebaudioside-C | 0% | 4% | 2% | 8% |
| Rebaudioside-D | 0% | 0.30% | 0% | 1% |
| Rebaudioside-E | 0% | 0.30% | 0% | 1% |
| | 7% | 41% | 24% | 100% |

Distribution of Glycosides in Stevia rebuadiana Leaves

Methods to selectively extract one or another of the gylocsides have been previously disclosed.

As seen in Table 1, the principle steviol glycoside found in the plant is referred to as stevioside. Stevioside typically represents about 57% of the glycosides that are present in a stevia extract.

Other glycosides found in the plant found in smaller quantities are noted in Table 1. Each has a different sweetness level and taste profile. Several grades of stevia are available, better grades having a higher rebaudioside A level as they contribute lower bitter taste levels. For these compositions, stevia extracts with rebaudioside A level higher than 80 wt % relative to all steviol glycosides are preferred with those with 90 wt % being more preferred and those with >95% being even more preferred.

Many products containing stevia extract are available. Table 2 shows commonly available products available in the Japan and the United States. The stevia extracts are generally blended with bulking ingredients to provide a manageable quantity for the user to dispense on whatever food product they wish to sweeten. For example, the SWEETLEAF® brand STEVIAPLUS product marketed by Wisdom Natural Brands is bulked maltodextrin or FOS. Without a bulking agent, the amount of stevia sweetener needed would be about 20 to about 25 mg. because stevia is about 300 times sweeter than sucrose. This amount is too small to reliably dispense from a sachet or other typical sweetener package. Other bulking agents that can be used include sugar alcohols, such as erythritol. As with other high intensity sweetener products, such as SPLENDA® brand No Calorie Sweetener or EQUAL® brand sweetener, the amount of bulking agent used is typically the smallest amount that provides for accurate delivery.

Table 2 also shows the ratio of bulking agents to stevia, as well as the sweetness contribution from the stevia where the bulking agent contributes sweetness (as with bulking with sugar alcohols) for currently known products. Also shown is the approximate amount of stevia required in the composition required to deliver equivalent sweetness of 1 g. of sugar in water.

TABLE 2

| | Relative Sweetness | | | | HIS | | | | Stevita | | Japanese |
|---|---|---|---|---|---|---|---|---|---|---|---|
| | | | g. | Energy | Market | | Stevia | NSI | supreme | Stevia | Stevia |
| | | g. | SES | kcals | reference | | Plus | Stevia | packets | spoonable | blend |
| | | per | per | per | Maltodextrin | Sugar | FOS | Stevia | Stevia | Stevia | Erythritol |
| Sweetener/Ingredient | sucrose = 1 | Tsp SES | kcal | g. | Sucralose | Sucrose | Stevia 65 | FOS | Erythritol | Erythritol | Stevia 65 |
| Maltodextrin | 0.01 | 400 | 0.00 | 4.0 | 1 | | | 0.50 | | | 0.00 |
| FOS | 0.10 | 40.0 | 0.07 | 1.5 | | | 1.00 | 0.48 | | | 0.00 |
| Erythritol | 0.70 | 5.71 | | 0.0 | | | | | 1.00 | 1.00 | 98.70 |
| Fructose | 1.05 | 3.81 | 0.26 | 4.0 | | | | | | | 0.00 |
| Molasses Solids | 1.00 | 4.00 | 0.25 | 4.0 | | | | | | | 0.00 |
| Agave Nector | 1.05 | 3.81 | 0.26 | 4.0 | | | | | | | 0.00 |
| (hydrolyzed) | | | | | | | | | | | |
| Sucralose | 600 | 0.0067 | | 0.0 | 0.0134 | | | | | | |
| Sucrose | 1.00 | 4.00 | 0.25 | 4.0 | | 4.00 | | | | | 0.00 |
| Concentrated Stevia | 330 | 0.0121 | | 0.0 | | | | | | | |
| (99 reb) | | | | | | | | | | | |
| Concentrated Stevia | 310 | 0.0129 | | 0.0 | | | | | | | |
| (90 reb) | | | | | | | | | | | |
| Concentrated Stevia | 291 | 0.0138 | | 0.0 | | | | | | | |
| (80 reb) | | | | | | | | | | | |
| Concentrated Stevia | 261 | 0.0153 | | 0.0 | | | | | 0.0450 | 0.0128 | |
| (65 reb) | | | | | | | | | | | |
| Stevia Extract | 180 | 0.0222 | | 0.0 | | | 0.0217 | 0.0250 | | | 1.30 |
| (~24% reb) | | | | | | | | | | | |
| Batch | | | | | 1.0134 | 4.0000 | 1.0217 | 1.0050 | 1.0450 | 1.0128 | 100.0000 |
| g stevia/batch | | | | | 0.0000 | 0.0000 | 0.0217 | 0.0250 | 0.0450 | 0.0128 | 1.3000 |
| mg stevia/tsp SES | | | | | 0.0 | 0.0 | 21.6 | 21.9 | 14.5 | 12.7 | 17.1 |
| g SES/batch | | | | | 8.05 | 4.00 | 4.01 | 4.56 | 12.45 | 4.05 | 303.45 |
| tsp SES/batch | | | | | 2.01 | 1.00 | 1.00 | 1.14 | 3.11 | 1.01 | 75.86 |
| g. SES/G. | | | | | 7.94 | 1.00 | 3.92 | 4.54 | 11.91 | 4.00 | 3.03 |
| g./tsp SES | | | | | 0.504 | 4.000 | 1.020 | 0.882 | 0.336 | 1.000 | 1.318 |
| cal/batch | | | | | 4.00 | 16.00 | 1.50 | 2.72 | 0.00 | 0.00 | 0.00 |
| cal/tsp SES | | | | | 1.99 | 16.00 | 1.50 | 2.39 | 0.00 | 0.00 | 0.00 |
| % of sweetness from | | | | | 0.0% | 0.0% | 97.5% | 98.8% | 94.4% | 82.7% | 77.2% |
| Stevia | | | | | | | | | | | |
| wt % stevia | | | | | 0.00% | 0.00% | 2.12% | 2.49% | 4.31% | 1.27% | 1.30% |

Several observations can be made about the current products depicted in Table 2. All require greater than about 6.7 mg. of stevia extract to deliver a teaspoon of SES with most requiring about 20 mg. Also, in most cases the stevia provides most of the sweetness. One exception is the stevia bulk product, which uses a sweet sugar alcohol as a bulking agent. In this product the stevia provides about 30% of the sweetness. However, this product uses a standard stevia extract and still retains a licorice note despite dilution with the sugar alcohol.

The amount of any particular ingredient or combination of ingredients used in the compositions of the present invention can be expressed as weight ratios, sweetness contributions, or mgs of stevia extract per SES. For this disclosure 99% rebaudioside A is assumed to have a sweetness intensity of 330, 90% rebaudioside A is assumed to have a sweetness intensity of 310, 80% rebaudioside A is assumed to have a sweetness intensity of 291, and stevia extract (about 40% rebaudioside A) is assumed to have a sweetness intensity of 180. It is well known that sweetness intensity varies with concentration. FIG. 1 (from “Use of Stevia Rebaudiana sweeteners in Japan”, Kenji Mizutani et.al.) shows the concentration curve for the stevia extract and rebaudioside A. For this disclosure the intensity was chosen to match that expect in a normal cup of coffee (about 2 tsp of sucrose).

The sweet contribution from high rebaudioside A stevia extracts can be any amount less than about 96.5%, preferably between about 96.5 and about 50%, and more preferably between about 93.3 and 5 about 0%, and even more preferably between about 93.3 and about 85%. While lower rebaudioside concentrations provide even cleaner tastes, they increase the caloric content to unacceptable levels given the caloric content of the simple sugar used in compositions of the present invention. The sweetness intensity can be any level consistent with the preferred ratio of simple sugar to stevia.

In the compositions of the present invention, the stevia extract can be any purified extract in which the relative portion of rebaudioside A to stevioside is increased over that found in the native leaves. It is preferred that the concentration be greater than 80% w/w of all sweet steviol glycosides and even more preferred to be greater than 96.5% w/w and even more preferred than 95% w/w.

### Simple Sugars:

The simple sugar can be any sweet mono or disaccharide, including (but not limited to) sucrose, glucose, or fructose, or combinations thereof. Sucrose and fructose are preferred. The simple sugar is also preferably refined to eliminate brown sweet note, especially molasses and caramel notes. Minimally sweet non-polymeric materials, such as FOS, should also be minimized.

### Other Sweeteners

Additional sweeteners that can be added to the stevia-simple sugar combination include fructooligosaccharide, trehelose, a sugar alcohol, tagatose, a nutritive sugar, a high intensity sweetener, and mixtures thereof.

### Other Components

The compositions can contain other components, including flavor, aroma, other nutritional component, binders, and mixtures thereof.

As used herein, unless otherwise indicated, the term “flavor” means any food-grade material that may be added to the present compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “aroma” means any food-grade volatile substance that may be employed to produce a desired scent, for example, when mixed with a foodstuff. Aromas useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone (juniper, common sage, Nootka cypress, and wormwood), thymol (camphor-like), trimethylamine (fish), vanillin (vanilla), and combinations thereof. Preferred aroma components according to the present invention include, essential oils (citrus oil), expressed oils (orange oil), distilled oils (rose oil), extracts (fruits), benzaldehyde, d-limonene, furfural, menthol, methyl butanoate, pentyl butanoate, salts, derivatives, and combinations thereof.

The aroma may be present in any amount in the composition. Preferably, the aroma component is present in an amount from about 2- to about 10-times the detectable amount. More preferably, the aroma component is present in an amount from about 2- to about 5-times the detectable amount. As used herein, unless otherwise indicated, the term “detectable amount” is the amount of the aroma component required to produce a scent detectable in the foodstuff.

As used herein, unless otherwise indicated, the term “binder” refers to any food-grade material that is suitable for facilitating the pressing and formation of tablets. The selection of an appropriate binder is not critical and embraces any conventional binder so long as the binder does not substantially interfere with the self-mixing or the organoleptic properties of the foodstuff. Non-limiting examples of suitable binders useful in the present invention, include microcrystalline cellulose, gum tragacanth, gelatin, leucine, lactose, and combinations thereof. Preferably, the binder, if used, accounts for about 10% to about 15%, by weight of the total composition.

### Methods of Making

Compositions of the present invention can be made by any method known to those skilled in the art that provide homogenous even or homogeneous mixtures of the ingredients. These methods include dry blending, spray drying, agglomeration, wet granulation, compaction, co-crystalization and the like.

The sweetening composition can be packaged in sachets or packets, dissolvable sweetening strips, sprays, drops, as a bulk sweetener, in cubes, or any normal sugar forms. Unit doses forms like sachets and cubes can contain from about 2 to about 10 g. of SES. Bulk products can be formulated to contain from about 2 to about 100 g. of SES per teaspoon of volume.

The sweetening composition of the present invention can be provided to consumers in any form suitable for delivery into the comestible to be sweetened, including sachets, packets, bulk bags or boxes, cubes, tablets, mists, drops, or dissolvable strips. The composition can be delivered as a unit dose or in bulk form.

The unit dose can be any customary dose, e.g., a gram, a cup, or a teaspoon. These unit forms typically contain from about 2 to about 10 g. of SES. A composition of the present invention can deliver about 0.02 to about 0.001 g. of stevia per unit package, more preferably about 0.005 to about 0.0015 g. of stevia per unit package, and even more preferably about 0.003 to about 0.0020 g. of stevia per unit package.

The compositions of the present invention can have from about 1 to about 12 kcals per teaspoon of SES.

The following examples are provided to further illustrate the compositions and methods of the present invention. These examples are illustrative only and are not intended to limit the scope of the invention in any way.

### EXAMPLES

### Example 1

100 g. of DOMINO® brand confectioners sugar (sucrose) (Domino Foods, Inc., Baltimore, MD) and 2.12 g. of stevia extract (Idyll Life Co., Ltd., Bangkok, Thailand), which has a rebaudioside A concentration of 99wt % relative to all steviol glycosides, are mixed and dry blended by sequential cutting and remixing (e.g., v-blending). The resulting mixture has a calculated SES (based on reported rebaudioside-A sweetness intensity of 330× sucrose) of 8 grams. of sucrose per gram.

TABLE 3-1

| | Relative Sweetness | | | Energy | |
|---|---|---|---|---|---|
| | | g. | g. SES | kcals | Example 1 |
| | | per | per | per | Sucrose |
| Sweetener/Ingredient | sucrose = 1 | Tsp SES | kcal | g. | Stevia 99 |
| Maltodextrin | 0.01 | 400 | 0.00 | 4.0 | |
| FOS | 0.10 | 40.0 | 0.07 | 1.5 | |
| Erythritol | 0.70 | 5.71 | | 0.0 | |
| Fructose | 1.05 | 3.81 | 0.26 | 4.0 | |
| Molassas Solids | 1.00 | 4.00 | 0.25 | 4.0 | |
| Agave Nector (hydrolysed) | 1.05 | 3.81 | 0.26 | 4.0 | |
| Sucralose | 600 | 0.0067 | | 0.0 | |
| Sucrose | 1.00 | 4.00 | 0.25 | 4.0 | 100.00 |
| Concentrated Stevia (99 reb) | 330 | 0.0121 | | 0.0 | 2.12 |
| Concentrated Stevia (90 reb) | 310 | 0.0129 | | 0.0 | |
| Concentrated Stevia (80 reb) | 291 | 0.0138 | | 0.0 | |
| Concentrated Stevia (65 reb) | 261 | 0.0153 | | 0.0 | |
| Stevia Extract (~24% reb) | 180 | 0.0222 | | 0.0 | |
| Batch | | | | | 102.1200 |
| g stevia/batch | | | | | 2.1200 |
| mg stevia/tsp SES | | | | | 10.6 |
| g SES/batch | | | | | 799.18 |
| tsp SES/batch | | | | | 199.80 |
| g. SES/G. | | | | | 7.83 |
| g./tsp SES | | | | | 0.511 |
| cal/batch | | | | | 400.00 |
| cal/tsp SES | | | | | 2.00 |
| % of sweetness from Stevia | | | | | 87.5% |
| wt % stevia | | | | | 2.08% |

### Example 2

2 g. of the blend from Example 1 (Sample A) and 2 packets (about 2 g.) of STEVIAPLUS® Sweetleaf® brand Stevia (Wisdom Natural Brands, Gilbert, AZ) (Sample B) are each mixed with 160 g. of hot water from a Flavia Brand Coffee Maker (Flavia Beverage Systems, West Chester, Pa.). Each packet used in Sample B is noted on the box to contain about 2 teaspoons of SES and 1 g. of FOS. Therefore, each packet has equivalent SES at about 10% sucrose solution equivalent in the 160 grams of water Typical stevia extracts contain less than about 40% rebaudioside A.

TABLE 3-2

| | Relative Sweetness | | | | Example 2 | |
|---|---|---|---|---|---|---|
| | | | g. | Energy | A | B |
| | | G. per | SES per | kcals | Sucrose | FOS |
| Sweetener/Ingredient | sucrose = 1 | Tsp SES | kcal | per g. | Stevia 99 | Stevia 65 |
| Maltodextrin | 0.01 | 400 | 0.00 | 4.0 | | |
| FOS | 0.10 | 40.0 | 0.07 | 1.5 | | 2.00 |
| Erythritol | 0.70 | 5.71 | | 0.0 | | |
| Fructose | 1.05 | 3.81 | 0.26 | 4.0 | | |
| Molasses Solids | 1.00 | 4.00 | 0.25 | 4.0 | | |
| Agave Nector (hydrolyzed) | 1.05 | 3.81 | 0.26 | 4.0 | | |
| Sucralose | 600 | 0.0067 | | 0.0 | | |
| Sucrose | 1.00 | 4.00 | 0.25 | 4.0 | 1.96 | |
| Concentrated Stevia (99 reb) | 330 | 0.0121 | | 0.0 | 0.04 | |
| Concentrated Stevia (90 reb) | 310 | 0.0129 | | 0.0 | | |
| Concentrated Stevia (80 reb) | 291 | 0.0138 | | 0.0 | | |
| Concentrated Stevia (65 reb) | 261 | 0.0153 | | 0.0 | | |
| Stevia Extract (~24% reb) | 180 | 0.0222 | | 0.0 | | 0/0878 |
| Batch | | | | | 2.0000 | 2.0878 |
| g stevia/batch | | | | | 0.0415 | 0/0878 |
| mg stevia/tsp SES | | | | | 10.6 | 21.9 |
| g SES/batch | | | | | 15.65 | 16.02 |
| tsp SES/batch | | | | | 3.91 | 4.01 |
| g. SES/G. | | | | | 7.83 | 7.68 |
| g./tsp SES | | | | | 0.511 | 0.521 |
| cal/batch | | | | | 7.83 | 3.00 |
| cal/tsp SES | | | | | 2.00 | 0.75 |
| % of sweetness from Stevia | | | | | 87.5% | 98.8% |
| wt % stevia | | | | | 2.08% | 4.20% |

The samples are consumed warm by three panelists. Consensus opinion is that both samples are around the same sweetness level. Sample A has a clean sweet taste with no non-sugar off notes. Sample B tastes bitter and has licorice notes.

### Example 3

Five samples are made. Each starts with 8 oz. of hot water from a Flavia Brand Coffee Maker (Flavia Beverage Systems, West Chester, Pa.)
Sample A 1 packet of SPLENDA® brand No Calorie Sweetener (McNeil Nutritionals, LLC, Ft. Washington, Pa.)
Sample B 1.2 g. blend form Example 1
Smaple C 1.74 g. blend from Example 1
Sample D 8 g. sucrose
Sample E 1 g. confectioners sugar (sucrose)

TABLE 3-3

| | Relative Sweetness | | | | Example 3 | | | | |
|---|---|---|---|---|---|---|---|---|---|
| | | | g. | Energy | A | | | | E |
| | | g. | SES | kcals | md | B | C | | sucrose |
| | | per | per | per | sucralose | sucrose | sucrose | D | Stevia 65 |
| Sweetener/Ingredient | sucrose = 1 | Tsp SES | kcal | g. | (Splenda) | Stevia 99 | Stevia 99 | sucrose | (Domino) |
| Maltodextrin | 0.01 | 400 | 0.00 | 4.0 | 1.000 | | | | |
| FOS | 0.10 | 40.0 | 0.07 | 1.5 | | | | | |
| Erythritol | 0.70 | 5.71 | | 0.0 | | | | | |
| Fructose | 1.05 | 3.81 | 0.26 | 4.0 | | | | | |
| Molasses Solids | 1.00 | 4.00 | 0.25 | 4.0 | | | | | |
| Agave Nector (hydrolyzed) | 1.05 | 3.81 | 0.26 | 4.0 | | | | | |
| Sucralose | 600 | 0.0067 | | 0.0 | 0.0134 | | | | |
| Sucrose | 1.00 | 4.00 | 0.25 | 4.0 | | 1.18 | 1.70 | 8.00 | 1.00 |
| Concentrated Stevia (99 reb) | 330 | 0.0121 | | 0.0 | | 0.02 | 0.04 | | |
| Concentrated Stevia (90 reb) | 310 | 0.0129 | | 0.0 | | | | | |
| Concentrated Stevia (80 reb) | 291 | 0.0138 | | 0.0 | | | | | |
| Concentrated Stevia (65 reb) | 261 | 0.0153 | | 0.0 | | | | | |
| Stevia Extract (~24% reb) | 180 | 0.0222 | | 0.0 | | | | | |
| Batch | | | | | 1.0134 | 1.2000 | 1.7400 | 8.0000 | 1.0000 |
| g stevia/batch | | | | | 0.0000 | 0.0249 | 0.0361 | 0.0000 | 0.0000 |
| mg stevia/tsp SES | | | | | 0.0 | 10.6 | 10.6 | 0.0 | 0.0 |
| g SES/batch | | | | | 8.05 | 9.39 | 13.62 | 8.00 | 1.00 |
| tsp SES/batch | | | | | 2.01 | 2.35 | 3.40 | 2.00 | 0.25 |
| g. SES/G. | | | | | 7.94 | 7.83 | 7.83 | 1.00 | 1.00 |
| g./tsp SES | | | | | 0.504 | 0.511 | 0.511 | 4.000 | 4.000 |
| cal/batch | | | | | 4.00 | 4.70 | 6.82 | 32.00 | 4.00 |
| cal/tsp SES | | | | | 1.99 | 2.00 | 2.00 | 16.00 | 16.00 |
| % of sweetness from Stevia | | | | | 0.0% | 87.5% | 87.5% | 0.0% | 0.0% |
| wt % stevia | | | | | 0.00% | 2.08% | 2.08% | 0.00% | 0.00% |

The samples are tasted warm and rated for sweetness level as follows: A is slightly sweeter than C, which is sweeter than B and D, which are about the same and much sweeter than E, which has a barely perceptible sweetness.

### Example 4

Four samples re made and each starts with 8 oz. of FLAVIA® brand blueberry tea (Flavia Beverage Systems, West Chester, Pa.).
Sample A 1 packet of Splenda® brand No Calorie Sweetener (McNeil Nutritionals, LLC., Ft. Washington, Pa.)
Sample B 1.2 g. blend form Example 1
Sample C 1 packet STEVIAPLUS® Sweetleaf® brand Stevia
Sample D 8 g. sucrose

TABLE 3-4

| | Relative Sweetness | | | | Example 4 | | | |
|---|---|---|---|---|---|---|---|---|
| | | | g. | Energy | A | | | |
| | | g. | SES | Kcals | md | B | C | |
| | | per | per | per | sucralose | sucrose | FOS | D |
| Sweetener/Ingredient | sucrose = 1 | Tsp SES | kcal | g. | (Splenda) | Stevia 99 | Stevia extract | sucrose |
| Maltodextrin | 0.01 | 400 | 0.00 | 4.0 | 1.000 | | | |
| FOS | 0.10 | 40.0 | 0.07 | 1.5 | | | 1.000 | |
| Erythritol | 0.70 | 5.71 | | 0.0 | | | | |
| Fructose | 1.05 | 3.81 | 0.26 | 4.0 | | | | |
| Molasses Solids | 1.00 | 4.00 | 0.25 | 4.0 | | | | |
| Agave Nector (hydrolyzed) | 1.05 | 3.81 | 0.26 | 4.0 | | | | |
| Sucralose | 600 | 0.0067 | | 0.0 | 0.0134 | | | |
| Sucrose | 1.00 | 4.00 | 0.25 | 4.0 | | 1.18 | | 8.00 |
| Concentrated Stevia (99 reb) | 330 | 0.0121 | | 0.0 | | 0.02 | | |
| Concentrated Stevia (90 reb) | 310 | 0.0129 | | 0.0 | | | | |
| Concentrated Stevia (80 reb) | 291 | 0.0138 | | 0.0 | | | | |
| Concentrated Stevia (65 reb) | 261 | 0.0153 | | 0.0 | | | | |
| Stevia Extract (~24% reb) | 180 | 0.0222 | | 0.0 | | | 0.178 | |
| Batch | | | | | 1.0134 | 1.2000 | 1.178 | 8.0000 |
| g stevia/batch | | | | | 0.0000 | 0.0249 | 0.1780 | 0.0000 |
| mg stevia/tsp SES | | | | | 0.0 | 10.6 | 22.1 | 0.0 |
| g SES/batch | | | | | 8.05 | 9.39 | 32.19 | 8.00 |
| tsp SES/batch | | | | | 2.01 | 2.35 | 8.05 | 2.00 |
| g. SES/G. | | | | | 7.94 | 7.83 | 27.33 | 1.00 |
| g./tsp SES | | | | | 0.504 | 0.511 | 0.146 | 4.000 |
| cal/batch | | | | | 4.00 | 4.70 | 1.50 | 32.00 |
| cal/tsp SES | | | | | 1.99 | 2.00 | 0.19 | 16.00 |
| % of sweetness from Stevia | | | | | 0.0% | 87.5% | 99.7% | 0.0% |
| wt % stevia | | | | | 0.00% | 2.08% | 15.11% | 0.00% |

Three panelists taste the samples for preference and bitterness. Consensus ratings are as follows: Preference: A better than Band D which are very similar and both of which are better than C. Bitterness: A and D are equal and only slightly less bitter than B, which is much less bitter than C.

### Example 5

Four samples are made each starting with 8 oz. of FLAVIA® brand raspberry spark Tea.
Sample A 1 packet of SPLENDA brand No Calorie Sweetener
Sample B 1.2 g. blend form Example 1
Sample C 1 packet STEVIAPLUS® Sweetleaf® brand Stevia Sample D 8 g. sucrose

| | Relative sweetness | | | | Example 5 | | | |
|---|---|---|---|---|---|---|---|---|
| | | | g. | Energy | A | | | |
| | | g. | SES | kcals | md | B | C | |
| | | per | per | per | sucralose | sucrose | FOS | D |
| Sweetener/Ingredient | sucrose = 1 | Tsp SES | kcal | g. | (Splenda) | Stevia 99 | Stevia extract | sucrose |
| Maltodextrin | 0.01 | 400 | 0.00 | 4.0 | 1.000 | | | |
| FOS | 0.10 | 40.0 | 0.07 | 1.5 | | | 1 | |
| Erythritol | 0.70 | 5.71 | | 0.0 | | | | |
| Fructose | 1.05 | 3.81 | 0.26 | 4.0 | | | | |
| Molasses Solids | 1.00 | 4.00 | 0.25 | 4.0 | | | | |
| Agave Nector (hydrolyzed) | 1.05 | 3.81 | 0.26 | 4.0 | | | | |
| Sucralose | 600 | 0.0067 | | 0.0 | 0.0134 | | | |
| Sucrose | 1.00 | 4.00 | 0.25 | 4.0 | | 1.18 | | 8.00 |
| Concentrated Stevia (99 reb) | 330 | 0.0121 | | 0.0 | | 0.02 | — | |
| Concentrated Stevia (90 reb) | 310 | 0.0129 | | 0.0 | | | | |
| Concentrated Stevia (80 reb) | 291 | 0.0138 | | 0.0 | | | | |
| Concentrated Stevia (65 reb) | 261 | 0.0153 | | 0.0 | | | | |
| Stevia Extract (~24% reb) | 180 | 0.0222 | | 0.0 | | | .178 | |
| Batch | | | | | 1.0134 | 1.2000 | 1.178 | 8.0000 |
| g stevia/batch | | | | | 0.0000 | 0.0249 | 0.1780 | 0.0000 |
| mg stevia/tsp SES | | | | | 0.0 | 10.6 | 22.2 | 0.0 |
| g SES/batch | | | | | 8.05 | 9.39 | 32.10 | 8.00 |
| tsp SES/batch | | | | | 2.01 | 2.35 | 8.02 | 2.00 |
| g. SES/G. | | | | | 7.94 | 7.83 | 27.25 | 1.00 |
| g./tsp SES | | | | | 0.504 | 0.511 | 0.147 | 4.000 |
| cal/batch | | | | | 4.00 | 4.70 | 4.00 | 32.00 |
| cal/tsp SES | | | | | 1.99 | 2.00 | 0.50 | 16.00 |
| % of sweetness from Stevia | | | | | 0.0% | 87.5% | 100.0% | 0.0% |
| wt % stevia | | | | | 0.00% | 2.08% | 15.11% | 0.00% |

Three panelists taste the samples and judge them for preference and bitterness. Consensus ratings are as follows: Preference: B slightly better than A, which was slightly better to D, and much better than C. Bitterness A, B, and D are similar and are less bitter than C.

### Example 6

Two additional samples are made with each starting with 8 oz of hot water from a Flavia Brand Coffee Maker (Flavia Beverage Systems, West Chester, Pa.).
Sample A 12 g. agave nectar, 70% solids, and fully hydrolysed agave inulin (fructose), 8 g. of water, and 0.21 g. of stevia extract (Idyll Life Co., Ltd., Bangkok, Thailand), which has a rebaudioside A concentration of 99 wt % relative to all steviol glycosides
Sample B 10 g. of AUNT PATTY'S® brand molasses crystals (GloryBee Foods, Inc, Eugene, Oreg.), 10 g. of water, 0.212 g. of stevia extract (Idyll Life Co., Ltd., Bangkok, Thailand), which has a rebaudioside A concentration of 99wt % relative to all steviol glycosides.

TABLE 3-6

| | Relative Sweetness | | | | | |
|---|---|---|---|---|---|---|
| | | | g. | Energy | Example 6 | |
| | | g. | SES | kcals | A | B |
| | | per | per | per | agave | molasses |
| Company.Sweetener/Ingredient | sucrose = 1 | Tsp SES | kcal | g. | Stevia 99 | Stevia 99 |
| Maltodextrin | 0.01 | 400 | 0.00 | 4.0 | | |
| FOS | 0.10 | 40.0 | 0.07 | 1.5 | | |
| Erythritol | 0.70 | 5.71 | | 0.0 | | |
| Fructose | 1.05 | 3.81 | 0.26 | 4.0 | | |
| Molasses Solids | 1.00 | 4.00 | 0.25 | 4.0 | | 10.00 |
| Agave Nector (hydrolyzed) | 1.05 | 3.81 | 0.26 | 4.0 | 8.4 | |
| Sucralose | 600 | 0.0067 | | 0.0 | | |
| Sucrose | 1.00 | 4.00 | 0.25 | 4.0 | | |
| Concentrated Stevia (99 reb) | 330 | 0.0121 | | 0.0 | 0.2100 | 0.21 |
| Concentrated Stevia (90 reb) | 310 | 0.0129 | | 0.0 | | |
| Concentrated Stevia (80 reb) | 291 | 0.0138 | | 0.0 | | |
| Concentrated Stevia (65 reb) | 261 | 0.0153 | | 0.0 | | |
| Stevia Extract (~24% reb) | 180 | 0.0222 | | 0.0 | | |
| Batch | | | | | 8.6100 | 10.2100 |
| g stevia/batch | | | | | 0.2100 | 0.2100 |
| mg stevia/tsp SES | | | | | 10.8 | 10.6 |
| g SES/batch | | | | | 78.08 | 79.26 |
| tsp SES/batch | | | | | 19.52 | 19.81 |
| g. SES/G. | | | | | 9.07 | 7.76 |
| g./tsp SES | | | | | 0.441 | 0.515 |
| cal/batch | | | | | 33.60 | 40.00 |
| cal/tsp SES | | | | | 1.72 | 2.02 |
| % of sweetness from Stevia | | | | | 88.7% | 87.4% |
| wt % stevia | | | | | 2.44% | 2.06% |

The fructose blend has a clean sweet taste with barely perceptible bitterness. The molasses blend is sweet but has bitter, dirty notes.

### Example 7

Two samples are made.
Sample A 100 g. of sucrose (confectioners sugar) and 2.12 g. of stevia extract (Idyll Life Co., Ltd., Bangkok, Thailand), which has a rebaudioside A concentration of 99 wt % relative to all steviol glycosides.
Sample B 100 g. of FOS (Orafti North America, Malvern, Pa.) and 2.12 g. of stevia extract (Idyll Life Co., Ltd., Bangkok, Thailand), which has a rebaudioside A concentration of 99wt % relative to all steviol glycosides.

TABLE 3-7

| | Relative Sweetness | | | | | |
|---|---|---|---|---|---|---|
| | | | g. | Energy | Example 7 | |
| | | g. | SES | kcals | A | B |
| | | per | per | per | sucrose | FOS |
| Sweetener/Ingredient | sucrose = 1 | Tsp SES | kcal | g. | Stevia 99 | Stevia 99 |
| Maltodextrin | 0.01 | 400 | 0.00 | 4.0 | | |
| FOS | 0.10 | 40.0 | 0.07 | 1.5 | | 100 |
| Erythritol | 0.70 | 5.71 | | 0.0 | | |
| Fructose | 1.05 | 3.81 | 0.26 | 4.0 | | |
| Molasses Solids | 1.00 | 4.00 | 0.25 | 4.0 | | |
| Agave Nector (hydrolyzed) | 1.05 | 3.81 | 0.26 | 4.0 | | |
| Sucralose | 600 | 0.0067 | | 0.0 | | |
| Sucrose | 1.00 | 4.00 | 0.25 | 4.0 | 100 | |
| Concentrated Stevia (99 reb) | 330 | 0.0121 | | 0.0 | 2.1200 | 2.12 |
| Concentrated Stevia (90 reb) | 310 | 0.0129 | | 0.0 | | |
| Concentrated Stevia (80 reb) | 291 | 0.0138 | | 0.0 | | |
| Concentrated Stevia (65 reb) | 261 | 0.0153 | | 0.0 | | |
| Stevia Extract (~24% reb) | 180 | 0.0222 | | 0.0 | | |
| Batch | | | | | 102.1200 | 102.1200 |
| g stevia/batch | | | | | 2.1200 | 2.1200 |
| mg stevia/tsp SES | | | | | 10.6 | 12.0 |
| g SES/batch | | | | | 799.18 | 709.18 |
| tsp SES/batch | | | | | 199.80 | 177.30 |
| g. SES/G. | | | | | 7.83 | 6.94 |
| g./tsp SES | | | | | 0.511 | 0.576 |
| cal/batch | | | | | 400.00 | 150.00 |
| cal/tsp SES | | | | | 2.00 | 0.85 |
| % of sweetness from Stevia | | | | | 87.5% | 98.6% |
| wt % stevia | | | | | 2.08% | 2.08% |

A level, one teaspoon quantity of each sample is dissolved in 4 oz of hot water from a Flavia Brand Coffee Maker (Flavia Beverage Systems, West Chester, Pa.). and was tasted by two panelists. Both samples are judged to be about the same sweetness. Sample A has a clean sweet taste, while Sample B is slightly bitter.

### Example 8

Three samples were made using the same materials as example 7 to test along side Sample A from Example 7
Sample A 100 g. of sucrose (confectioners sugar) and 2.12 g. of stevia extract (from Example 7)
Sample B 50 g. of FOS and 2.12 g. of stevia extract
Sample C 25 g. of FOS and 2.12 g. of stevia extract
Sample D 5 g. of FOS and 2.12 g. of stevia extract

TABLE 3-8

| | | | | | Example 8 | | | |
|---|---|---|---|---|---|---|---|---|
| | Relative Sweetness | | | Energy | A | B | C | D |
| | | g. per | g. SES | kcals | sucrose | sucrose | sucrose | sucrose |
| Sweetener/Ingredient | sucrose = 1 | Tsp SES | Per kcal | per g. | Stevia 99 | Stevia 99 | Stevia 99 | Stevia 99 |
| Maltodextrin | 0.01 | 400 | 0.00 | 4.0 | | | | |
| FOS | 0.10 | 40.0 | 0.07 | 1.5 | | | | |
| Erythritol | 0.70 | 5.71 | | 0.0 | | | | |
| Fructose | 1.05 | 3.81 | 0.26 | 4.0 | | | | |
| Molasses Solids | 1.00 | 4.00 | 0.25 | 4.0 | | | | |
| Agave Nector (hydrolyzed) | 1.05 | 3.81 | 0.26 | 4.0 | | | | |
| Sucralose | 600 | 0.0067 | | 0.0 | | | | |
| Sucrose | 1.00 | 4.00 | 0.25 | 4.0 | 100.00 | 50.00 | 25.00 | 5.00 |
| Concentrated Stevia (99 reb) | 330 | 0.0121 | | 0.0 | 2.1200 | 2.1200 | 2.1200 | 2.1200 |
| Concentrated Stevia (90 reb) | 310 | 0.0129 | | 0.0 | | | | |
| Concentrated Stevia (80 reb) | 291 | 0.0138 | | 0.0 | | | | |
| Concentrated Stevia (65 reb) | 261 | 0.0153 | | 0.0 | | | | |
| Stevia Extract (~24% reb) | 180 | 0.0222 | | 0.0 | | | | |
| Batch | | | | | 102.1200 | 52.1200 | 27.1200 | 7.1200 |
| g stevia/batch | | | | | 2.1200 | 2.1200 | 2.1200 | 2.1200 |
| mg stevia/tsp SES | | | | | 10.6 | 11.3 | 11.7 | 12.0 |
| g SES/batch | | | | | 799.18 | 749.18 | 724.18 | 704.18 |
| tsp SES/batch | | | | | 199.80 | 187.30 | 181.05 | 176.05 |
| g. SES/G. | | | | | 7.83 | 14.37 | 26.70 | 98.90 |
| g./tsp SES | | | | | 0.511 | 0.278 | 0.150 | 0.040 |
| cal/batch | | | | | 400.00 | 200.00 | 100.00 | 20.00 |
| cal/tsp SES | | | | | 2.00 | 1.07 | 0.55 | 0.11 |
| % of sweetness from stevia | | | | | 87.5% | 93.3% | 96.5% | 99.3% |
| wt % stevia | | | | | 2.08% | 4.07% | 7.82% | 29.78% |

A level, one tsp quantity of each sample is dissolved in 6 oz. of hot water from a Flavia Brand Coffee Maker (Flavia Beverage Systems, West Chester, Pa.) and tasted by two panelists. Sample A and B are noted to be sweet and have no bitter taste, Sample C has a very slight bitter note, Sample D is very bitter.

The sweetness contribution for each sample is calculated as follows:
Sample A 87.5 of sweetness from rebaudioside A
Sample B 93.3 of sweetness from rebaudioside A
Sample C 96.5 of sweetness from rebaudioside A
Sample D 99.3 of sweetness from rebaudioside A

### Example 9

The four samples from Example 8 are mixed at different levels in 6 oz of hot water from a Flavia Brand Coffee Maker (Flavia Beverage Systems, West Chester, Pa.) to achieve about equi-sweet levels. The equi-sweet level is calculated based on about 4 teaspoons of SES and an assumed stevia sweetness intensity of 330× sucrose.
Sample A 2.04 g.
Sample B 1.12 g.
Sample C 0.60 g.
Sample D 0.16 g.

TABLE 3-9

| | Relative Sweetness | | | | | | | |
|---|---|---|---|---|---|---|---|---|
| | | | g. | Energy | | | | |
| | | g. | SES | kcals | Example 9 | | | |
| | | per | per | per | sucrose | sucrose | sucrose | sucrose |
| Sweetener/Ingredient | sucrose = 1 | Tsp SES | kcal | g. | Stevia 99 | Stevia 99 | Stevia 99 | Stevia 99 |
| Maltodextrin | 0.01 | 400 | 0.00 | 4.0 | | | | |
| FOS | 0.10 | 40.0 | 0.07 | 1.5 | | | | |
| Erythritol | 0.70 | 5.71 | | 0.0 | | | | |
| Fructose | 1.05 | 3.81 | 0.26 | 4.0 | | | | |
| Molasses Solids | 1.00 | 4.00 | 0.25 | 4.0 | | | | |
| Agave Nector (hydrolyzed) | 1.05 | 3.81 | 0.26 | 4.0 | | | | |
| Sucralose | 600 | 0.0067 | | 0.0 | | | | |
| Sucrose | 1.00 | 4.00 | 0.25 | 4.0 | 2.00 | 1.07 | 0.55 | 0.11 |
| Concentrated Stevia (99 reb) | 330 | 0.0121 | | 0.0 | 0.0424 | 0.0456 | 0.0469 | 0.0476 |
| Concentrated Stevia (90 reb) | 310 | 0.0129 | | 0.0 | | | | |
| Concentrated Stevia (80 reb) | 291 | 0.0138 | | 0.0 | | | | |
| Concentrated Stevia (65 reb) | 261 | 0.0153 | | 0.0 | | | | |
| Stevia Extract (~24% reb) | 180 | 0.0222 | | 0.0 | | | | |
| Batch | | | | | 2.0400 | 1.1200 | 0.6000 | 0.1600 |
| g stevia/batch | | | | | 0.0424 | 0.0456 | 0.0469 | 0.0476 |
| mg stevia/tsp SES | | | | | 10.6 | 11.3 | 11.7 | 12.0 |
| g SES/batch | | | | | 15.96 | 16.10 | 16.02 | 15.82 |
| tsp SES/batch | | | | | 3.99 | 4.02 | 4.01 | 3.96 |
| g. SES/G. | | | | | 7.83 | 14.37 | 26.70 | 98.90 |
| g./tsp SES | | | | | 0.511 | 0.278 | 0.150 | 0.040 |
| cal/batch | | | | | 7.99 | 4.30 | 2.21 | 0.45 |
| cal/tsp SES | | | | | 2.00 | 1.07 | 0.55 | 0.11 |
| % of sweetness from stevia | | | | | 87.5% | 93.3% | 96.5% | 99.3% |
| wt % stevia | | | | | 2.08% | 4.07% | 7.82% | 29.78% |

Sample A is noted to be sweet and have no bitter taste, Sample B has a very slight dirty note, Sample C has slight dirty note and a very slight bitter note, and Sample D has a dirty note and a slight bitter note.

### Example 10

Four Samples are made:
Sample A 10 g. of sucrose (confectioners sugar) and 0.2123 g. of stevia extract (99% Reb A) (Idyll Life Co., Ltd., Bangkok, Thailand)
Sample B 10 g. of sucrose (confectioners sugar) and 0.2295 g. of stevia extract (90% Reb A) (Zibo Inchcape Stevia Co, Shandong, China)
Sample C 10 g. of sucrose (confectioners sugar) and 0.2500 g. of stevia extract (80% Reb A) (Zibo Inchcape Stevia Co, Shandong, China)
Sample D 10 g. of sucrose (confectioners sugar) and 0.3889 g. of stevia extract (std extract ˜24% Reb A) (Zibo Inchcape Stevia Co, Shandong, China)

TABLE 3-10

| | Relative Sweetness | | | | | | | |
|---|---|---|---|---|---|---|---|---|
| | | | g. | Energy | Example 10 | | | |
| | | g. | SES | kcals | A | B | C | D |
| | | per | per | per | sucrose | sucrose | sucrose | sucrose |
| Sweetener/Ingredient | sucrose = 1 | Tsp SES | kcal | g. | Stevia 99 | Stevia 90 | Stevia 80 | Stevia 65 |
| Maltodextrin | 0.01 | 400 | 0.00 | 4.0 | | | | |
| FOS | 0.10 | 40.0 | 0.07 | 1.5 | | | | |
| Erythritol | 0.70 | 5.71 | | 0.0 | | | | |
| Fructose | 1.05 | 3.81 | 0.26 | 4.0 | | | | |
| Molasses Solids | 1.00 | 4.00 | 0.25 | 4.0 | | | | |
| Agave Nector (hydrolyzed) | 1.05 | 3.81 | 0.26 | 4.0 | | | | |
| Sucralose | 600 | 0.0067 | | 0.0 | | | | |
| Sucrose | 1.00 | 4.00 | 0.25 | 4.0 | 10.00 | 10.00 | 10.00 | 10.00 |
| Concentrated Stevia (99 reb) | 330 | 0.0121 | | 0.0 | 0.2123 | | | |
| Concentrated Stevia (90 reb) | 310 | 0.0129 | | 0.0 | | 0.2295 | | |
| Concentrated Stevia (80 reb) | 291 | 0.0138 | | 0.0 | | | 0.2500 | |
| Concentrated Stevia (65 reb) | 261 | 0.0153 | | 0.0 | | | | |
| Stevia Extract (~24% reb) | 180 | 0.0222 | | 0.0 | | | | 0.3889 |
| Batch | | | | | 10.2123 | 10.2295 | 10.2500 | 10.3889 |
| g stevia/batch | | | | | 0.2123 | 0.2295 | 0.2500 | 0.3889 |
| mg stevia/tsp SES | | | | | 10.6 | 11.3 | 12.1 | 19.4 |
| g SES/batch | | | | | 80.01 | 81.22 | 82.65 | 80.11 |
| tsp SES/batch | | | | | 20.00 | 20.30 | 20.66 | 20.03 |
| g. SES/G. | | | | | 7.83 | 7.94 | 8.06 | 7.71 |
| g./tsp SES | | | | | 0.511 | 0.504 | 0.496 | 0.519 |
| cal/batch | | | | | 40.00 | 40.00 | 40.00 | 40.00 |
| cal/tsp SES | | | | | 2.00 | 1.97 | 1.94 | 2.00 |
| % of sweetness from Stevia | | | | | 87.5% | 87.7% | 87.9% | 87.5% |
| wt % stevia | | | | | 2.08% | 2.24% | 2.44% | 374% |

2 g. of each sample is dissolved in 6 oz. of hot water from a Flavia Brand Coffee Maker (Flavia Beverage Systems, West Chester, Pa. and tasted. Sample A and B are noted to be sweet and have no bitter taste, Sample C has a very slight dirty note, Sample D has distinct bitter notes.

The samples are judged to be equi-sweet.

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents. Unless otherwise defined, all technical and scientific terms used herein have the same meaning as commonly understood by one of ordinary skill in the art to which this invention pertains. All publications, patent applications, patents, and other references mentioned herein are incorporated by reference in their entirety. In case of conflict, the present specification, including definitions, will control.

What is claimed is:

1. A reduced calorie sweetening composition comprising a stevia extract and a simple sugar, wherein the stevia extract provides from about 20% to about 97% of the sweetness and has a rebaudioside A level of from about 80 wt % to about 99.5 wt % relative to all steviol glycosides.

2. The sweetening composition of claim 1, wherein the stevia provides from about 85% to about 97% of the sweetness.

3. The sweetening composition of claim 1, wherein the sweetening composition has from about 0.01 to about 1 kcals per gram of SES.

4. The sweetening composition of claim 1, further comprising a member from the group consisting of a flavor, an aroma, a nutritional ingredient and combinations thereof.

5. The sweetening composition in claim 1, wherein the sweetening composition is a form selected from the group consisting of a non-flowable solid, a powder, a solution, a slurry, and a suspension.

6. The sweetener composition in claim 1 that is packaged in a unit dose selected from the group consisting of grams, teaspoons, tablespoons, cups, lbs, kilos, multiples thereof, and their SES equivalents.

7. The composition in claim 1 that contains less than about 1% sweetness from polymeric sweeteners.

8. A sweetening composition comprising stevia and a simple sugar selected from the group consisting of sucrose, fructose, glucose, and mixtures thereof, wherein the stevia has a rebaudioside A level of from about 80 wt % to about 99 wt % relative to all steviol glycosides.

9. The sweetening composition of claim 8, wherein the stevia provides from about 88% to about 97% of the sweetness.

10. The sweetening composition of claim 8, wherein the sweetening composition has from about 0.5 to about 1 kcals per gram of SES.

11. The sweetening composition of claim 8, further comprising a member from the group consisting of a flavor, an aroma, a nutritional ingredient and combinations thereof.

12. The sweetening composition of claim 8, wherein the sweetening composition is in a form selected from the group consisting of a non-flowable solid, a powder, a solution, a slurry, and a suspension.

13. The sweetening composition of claim 8, wherein the sweetening composition is packaged in a unit dose selected from the group consisting of SES, weight, volume, and combinations thereof.

14. The sweetening composition of claim 8, wherein the simple sugar is selected from the group consisting of sucrose, fructose, glucose, and mixtures thereof.

15. A reduced calorie sweetening composition comprising from about 2 wt % to about 4 wt % stevia extract and about 92 wt % to about 98 wt % simple sugar, wherein the stevia has a rebaudioside A level of from about 80 wt % to about 99 wt % relative to all steviol glycosides.

16. The sweetening composition of claim 15, wherein the stevia provides from about 88% to about 97% of the sweetness.

17. The sweetening composition of claim 16, wherein the sweetening composition has from about 0.5 to about 1 kcals per gram of SES.

18. The sweetening composition of claim 16, further comprising a member from the group consisting of a flavor, an aroma, a nutritional ingredient and combinations thereof.

19. The sweetening composition of claim 16, wherein the sweetening composition is a form selected from the group consisting of a non-flowable solid, a powder, a solution, a slurry, and a suspension.

20. The sweetening composition of claim 16, wherein the sweetening composition is packaged in a unit dose selected from the group consisting of grams, teaspoons, tablespoons, cups, lbs, kilos, multiples thereof, and there SES equivalents.

21. The sweetening composition of claim 16, wherein the simple sugar is selected from the group consisting of sucrose, fructose, glucose, and mixtures thereof.
